(19) United States
(12) Patent Application Publication
(10) Pub. No.: US 2014/0350936 A1
(43) Pub. Date: Nov. 27, 2014

(54) ELECTRONIC DEVICE

(71) Applicant: KABUSHIKI KAISHA TOSHIBA, Tokyo (JP)

(72) Inventor: Hirofumi Kanai, Fukaya-shi (JP)

(73) Assignee: KABUSHIKI KAISHA TOSHIBA, Tokyo (JP)

(21) Appl. No.: 14/243,533

(22) Filed: Apr. 2, 2014

(30) Foreign Application Priority Data
May 27, 2013 (JP) 2013-111258

(51) Int. Cl. G10L 15/08

(52) U.S. Cl. CPC G10L 15/08
USPC 704/251

(57) ABSTRACT

According to at least one embodiment, an electronic device includes storage and a processor. The storage stores a database including a plurality of names. The processor outputs an identified name based on a search of the database for a first name having one or more characteristics in common with a character string associated with speech data.

### CROSS-REFERENCE TO RELATED APPLICATIONS

This application is based upon and claims the benefit of priority from Japanese Patent Application No. 2013-111258, filed May 27, 2013, the entire contents of which are incorporated herein by reference.

### FIELD

Embodiments described herein relate generally to an electronic device that presents a name corresponding to the result of speech recognition from a database containing a plurality of names.

### BACKGROUND

In view of the present popularity of net shopping, it is desirable for users to be able to search for products by means of a speech recognition technique so that those unfamiliar with computers can take advantage of net shopping.

With speech recognition, it is sometimes impossible to search for an identified product name because of misrecognition in processing speech recognition. In such a case, a message to the speaker is displayed on an inquiry screen asking whether the words and phrases recognized by the machine are correct, and then the speaker selects whether the recognized result is correct or not. Although speech input is requested again when misrecognition occurs, speech cannot be recognized if misrecognition continues because of a speaker's accent or articulation.

Even when it is difficult to analyze speech itself because of a speaker's accent or articulation, improved accuracy of speech recognition is desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram illustrating a net shopping system configuration according to an embodiment.

FIG. 2 is an exemplary diagram illustrating a system configuration of an electronic device according to the embodiment.

FIG. 3 is an exemplary diagram illustrating a configuration of a net shopping application.

FIG. 4 is an exemplary diagram illustrating a configuration of a product database.

FIG. 5 is an exemplary diagram illustrating a configuration of a product database.

FIG. 6 is an exemplary flowchart illustrating a procedure of net shopping by the net shopping application.

FIG. 7 is an exemplary flowchart illustrating a procedure of net shopping by the net shopping application.

FIG. 8 is an exemplary diagram illustrating an image displayed on a display apparatus in net shopping.

FIG. 9 is an exemplary diagram illustrating an image displayed on the display apparatus in net shopping.

FIG. 10 is an exemplary diagram illustrating an image displayed on the display apparatus in net shopping.

FIG. 11 is an exemplary diagram illustrating an image displayed on the display apparatus in net shopping.

FIG. 12 is an exemplary diagram illustrating an image displayed on the display apparatus in net shopping.

FIG. 13 is an exemplary diagram illustrating an image displayed on the display apparatus in net shopping.

FIG. 14 is an exemplary diagram illustrating an image displayed on the display apparatus in net shopping.

FIG. 15 is an exemplary diagram illustrating a configuration of the net shopping application.

FIG. 16 is an exemplary diagram illustrating a syllable dictionary database of a product name.

### DETAILED DESCRIPTION

Various embodiments will be described hereinafter with reference to the accompanying drawings.

In general, according to one embodiment, an electronic device includes storage and a processor. The storage is configured to store a database comprising a plurality of names. The processor is configured to output an identified name based on a search of the database for a first name having one or more characteristics in common with a character string associated with speech data.

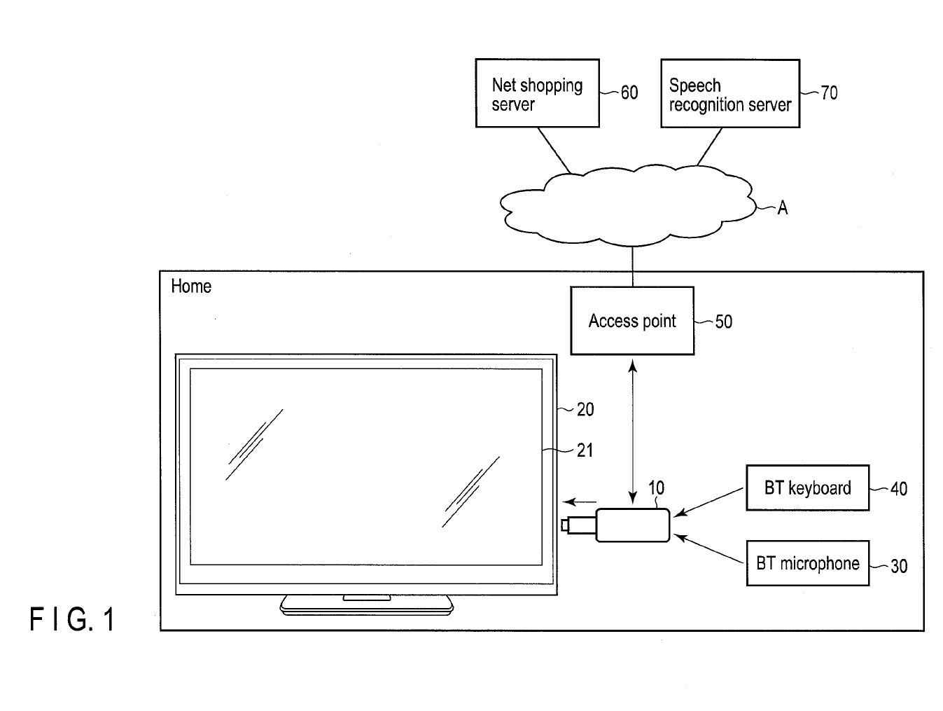

FIG. 1 is a diagram illustrating a configuration of a net shopping system according to the embodiment.

The net shopping system comprises an electronic device 10, a Bluetooth (Registered Trademark) microphone (BT microphone) 30, a Bluetooth keyboard (BT keyboard) 40, a display apparatus 20, an access point 50, a speech recognition server 70, a net shopping server 60, and the like.

The electronic device 10 can be realized as a tablet computer, a notebook personal computer, a smartphone, a slate-type computer, a stick-type computer, and the like. In the following, it is supposed that the electronic device 10 is realized as a stick-type computer.

The stick-type computer 10 acquires a product database that shows a list of products from the net shopping server 60 connected to a network (the Internet) via the access point 50. The stick-type computer 10 transmits voice data input from the BT microphone 30 to the speech recognition server 70 connected to a network (the Internet) via the access point 50. The speech recognition server 70 recognizes speech uttered by the user on the basis of the voice data. The speech recognition server 70 transmits to the stick-type computer 10 text data that represents the recognized result. On the basis of the text data, the stick-type computer 10 searches for a product from a database file. The electronic device 10 displays a product name found on the display apparatus 20. Using the BT keyboard 40, the user inputs a response to the stick-type computer 10 indicating whether or not the product found is correct. It should be noted that the BT keyboard 40 and the BT microphone 30 are independent devices. However, it is possible to use a device in which the BT keyboard 40 and the BT microphone 30 are integrated.

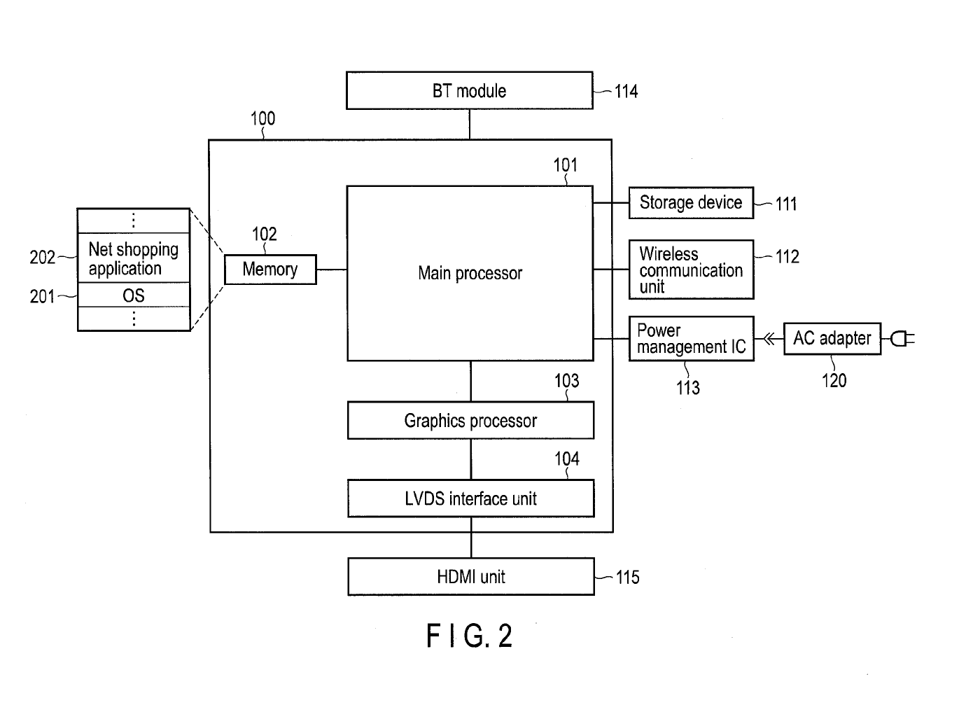

FIG. 2 is a diagram illustrating a system configuration of the electronic device 10 in the embodiment.

As shown in FIG. 2, the stick-type computer 10 comprises a processor 100, a storage device 111, a wireless communication unit 112, a power management IC 113, a Bluetooth module (BT module) 114, a HDMI (Registered Trademark) interface unit 115, and the like.

The storage device 111 is a non-volatile storage unit having a non-volatile memory, a flash memory, a magnetoresistive memory, a hard disk drive, and the like.

The wireless communication unit 112 communicates with the net shopping server 60 and the speech recognition server 70 connected to network A via the access point 50.

The BT module 114 communicates with the BT microphone 30 and the BT keyboard 40. The BT module 114 communicates with the BT microphone 30 to acquire voice data input via the BT microphone 30. The BT module 114 communicates with the BT keyboard 40 to acquire a signal corresponding to a key pressed on the BT keyboard 40.

The processor 100 comprises a main processor 101, a main memory 102, a graphics processor 103, and a LVDS interface unit 104, and the like.

The main processor 101 controls the operation of each type of module in the stick-type computer 10. The stick-type computer 10 executes each type of program that is loaded from the storage device 111 into the main memory 102. The program executed by the processor 100 includes each type of application program such as an operating system (OS) 201 and a net shopping application 202. The net shopping application 202 is a program to carry out net shopping.

The graphics processor 103 is a display controller that controls the display apparatus 20 used as a display monitor. The graphics processor 103 generates video data to display video on the display apparatus 20. The LVDS interface unit 104 converts the video data into a signal corresponding to LVDS (Low-voltage differential signaling).

The HDMI interface unit 115 converts a signal conforming to LVDS into a signal corresponding to the HDMI (High-Definition Multimedia Interface) standard.

The power management IC 113 is a single-chip microcomputer for power management. Also, the power management IC 113 uses power supplied from an AC adapter 120 to generate operation power that should be supplied to each component.

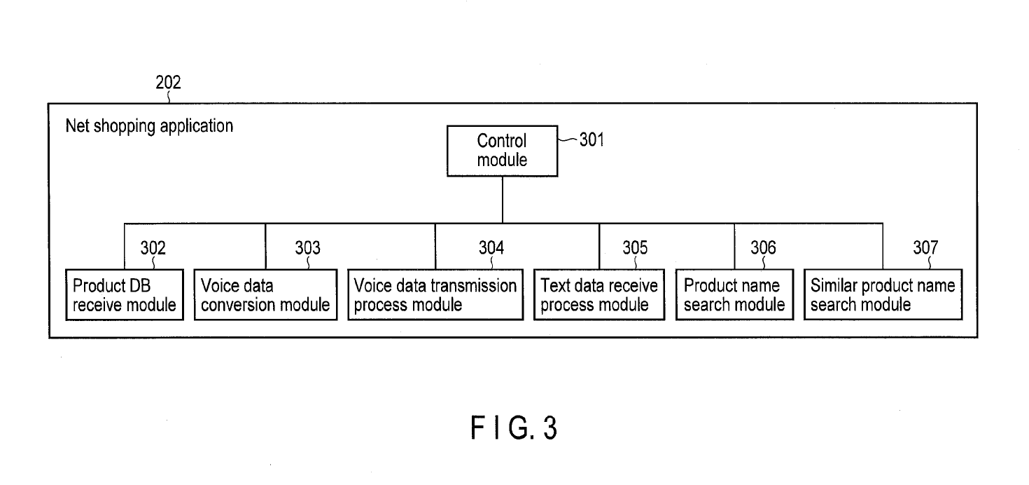

FIG. 3 is a block diagram illustrating a configuration of the net shopping application 202.

The net shopping application 202 comprises a control function 301, a product database acquisition function (product DB acquisition function) 302, a voice data conversion function 303, a voice data transmission process function 304, a text data reception process function 305, a product name search function 306, a similar product name search function 307, and the like.

The control function 301 controls the operation of the net shopping application 202. The product database acquisition function 302 uses the wireless communication unit 112 to execute a process to acquire a product database that shows a list of products available for sale in the net shopping server 60 from the net shopping server 60. The product database contains a plurality of product names.

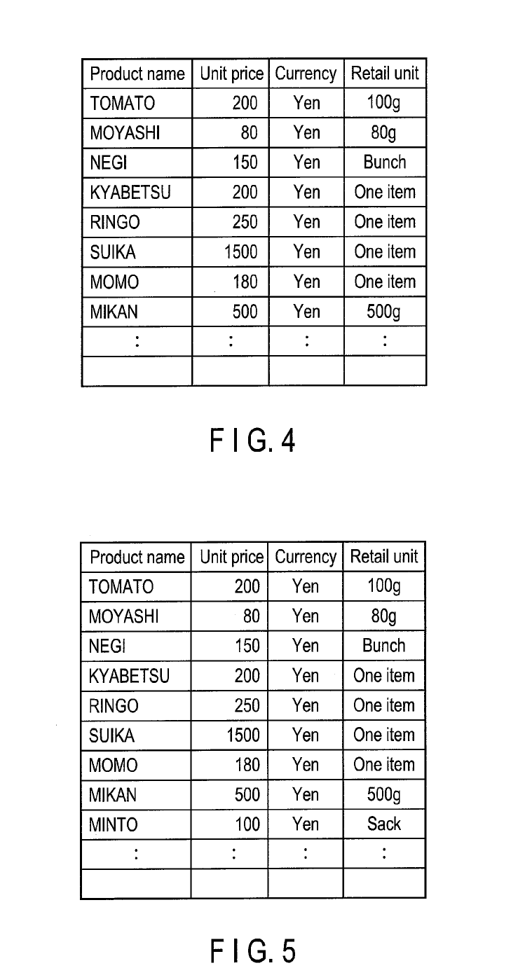

FIG. 4 is an exemplary diagram illustrating a configuration of a product database, to which a product name, unit price, currency, retail unit, and the like relate. The control function 301 stores in the storage device 111 the product database acquired by the product database acquisition function 302.

In an example of the product database shown in FIG. 4, a product name includes “TOMATO [apple]”, “MOYASHI [sprout]”, “NAGANEGI [long green onion]”, “KYABETSU [cabbage]”, “RINGO [apple]”, “SUIKA [watermelon]”, “NOMO [peach]”, and “ORENJI [orange]”. Also, in an example of the product database shown in FIG. 5, a product name includes “TOMATO [apple]”, “MOYASHI [sprout]”, “NAGANEGI [long green onion]”, “KYABETSU [cabbage]”, “RINGO [apple]”, “SUIKA [watermelon]”, “MONO [peach]”, “ORENJI [orange]”, and “MINTO [mint]”. The product database shown in FIG. 5 includes “MINTO [mint]”, which is not included in the product database shown in FIG. 4.

The voice data conversion function 303 converts voice data input via a voice data input unit into a format compatible with the speech recognition server 70. For example, the BT microphone 30 produces voice data in a format such as PCM (pulse code modulation) format or MP3 (MPEG Audio Layer-3) format of digital voice data, which is then read via the BT module 114 and converted into voice data in the FLAC (Free Lossless Audio Code) format, which, being more compact, imposes less of a network load.

The voice data transmission process function 304 uses the wireless communication unit 112 to execute a process of transmitting to the speech recognition server 70 voice data converted by the voice data conversion function 303. The text data reception process function 305 uses the wireless communication unit 112 to execute a process of receiving text data corresponding to the recognized result of voice data transmitted to the speech recognition server 70. The product name search function 306 searches for a corresponding product name from the product database based on a character string shown in the text data.

The similar product name search function 307 searches for a product name similar to a character string represented by text data, when the product name search function 306 cannot search for a product name from the product database. The similar product name search function 307 extracts from the product database a product name having the same number of characters as that of the character string, counts the number of matching characters and takes as a recognized speech result a product name having the greatest number of matches. The similar product name search part 307 extracts all of the product names, if there is a plurality of product names having the greatest number of matches.

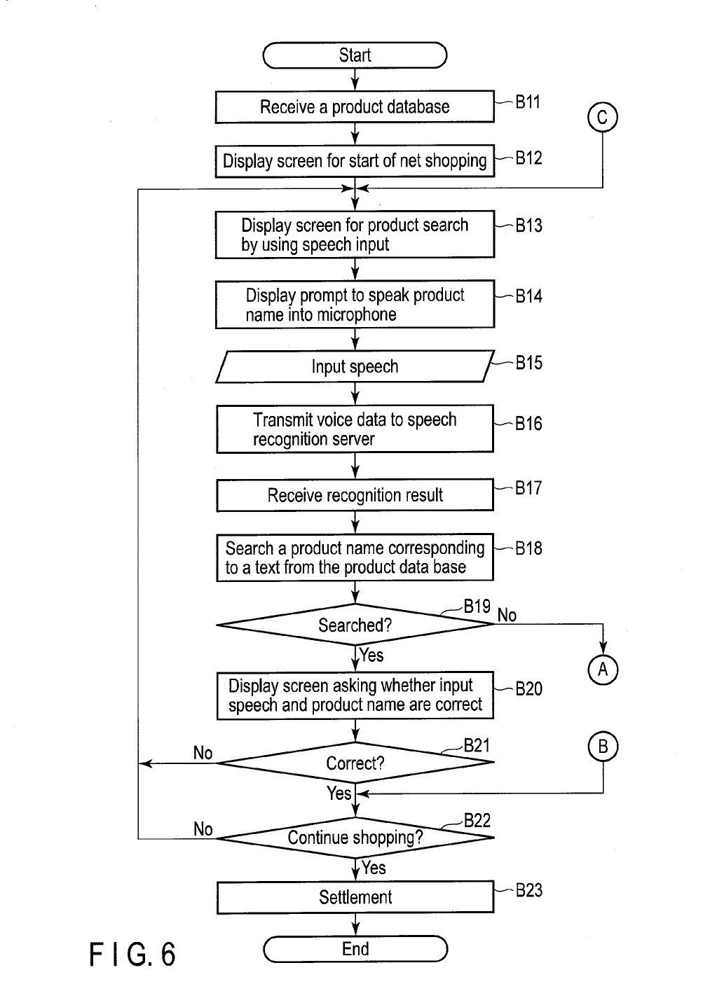

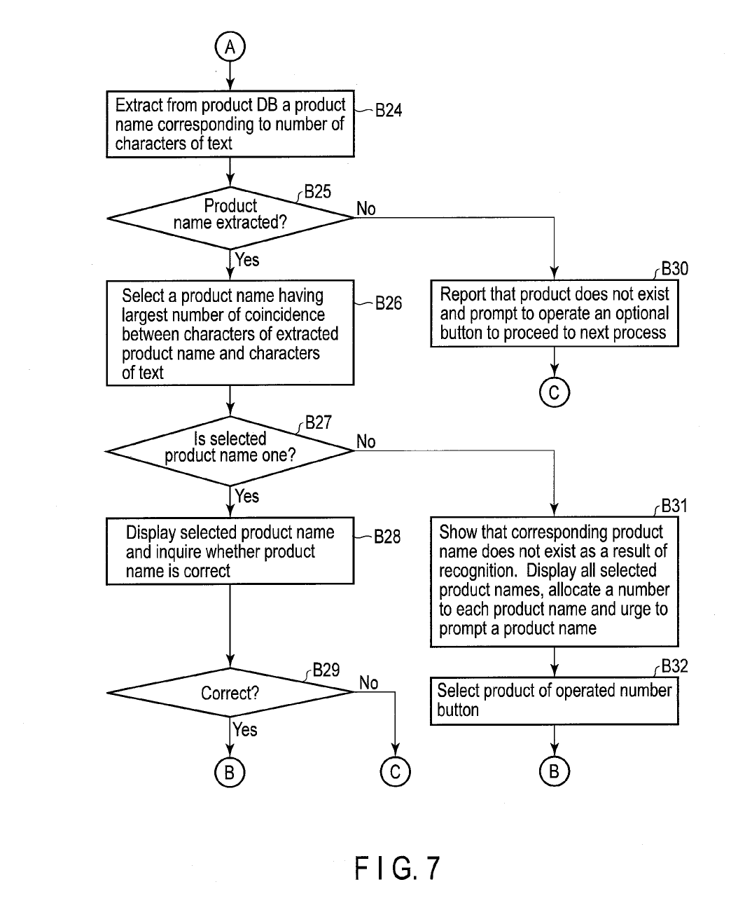

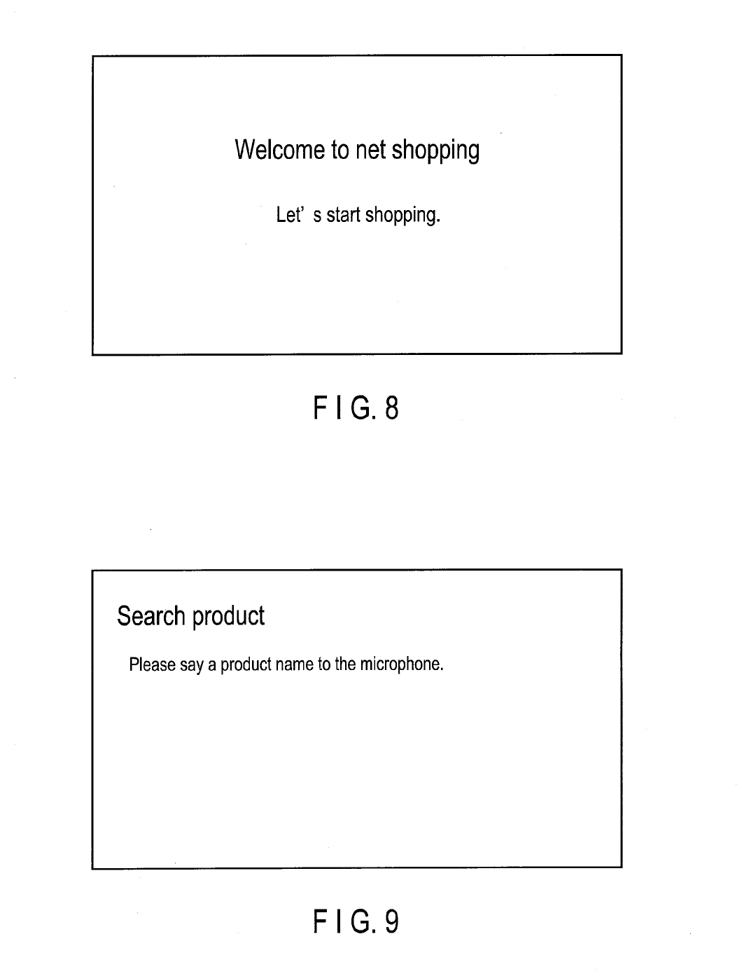

FIGS. 6 and 7 are flowcharts illustrating a procedure of net shopping by the net shopping application 202. FIGS. 8 to 14 are exemplary diagrams illustrating an image displayed in the display apparatus 20 in net shopping. Referring to FIGS. 6 and 7 and FIGS. 8 to 14, a procedure of net shopping will be explained.

First of all, when logging in the net shopping server 60, the product database acquisition function 302 acquires a product database from the net shopping server 60 (block B11). The control function 301 executes a process to display in the display apparatus 20 an image (FIG. 8) that shows net shopping has started (block B12).

The control function 301 executes a process to display an image showing the user that it is possible to search for a product (block B13). Further, the control function 301 executes a process to display an image (FIG. 9) which prompts the user to input speech for searching for a product by speech input (block B14).

The user prompted to speak can know when to say the name of a product that he or she wants to purchase on the screen shown in FIG. 9. Voice data corresponding to the speech is input to the net shopping application 20 from the BT microphone 30 via the BT module 114 (block B15). The voice data conversion function 303 converts the input voice data file into a format compatible with the speech recognition server 70. The voice data transmission process function 304 uses the wireless communication unit 112 to execute a process to transmit to the speech recognition server 70 the voice data the format of which has been converted (block B16).

The text data reception process function 305 uses the wireless communication unit 112 to execute a process to receive text data, which is a speech recognition result, from the speech recognition server 70 (block B17).

The product name search function 306 uses a character string shown in text data (hereinafter, referred to as a “recognized character string”) to search for a product name from the product database (block B18). The control function 301 determines whether a product name has been found by the product name search function 306. (block B19).

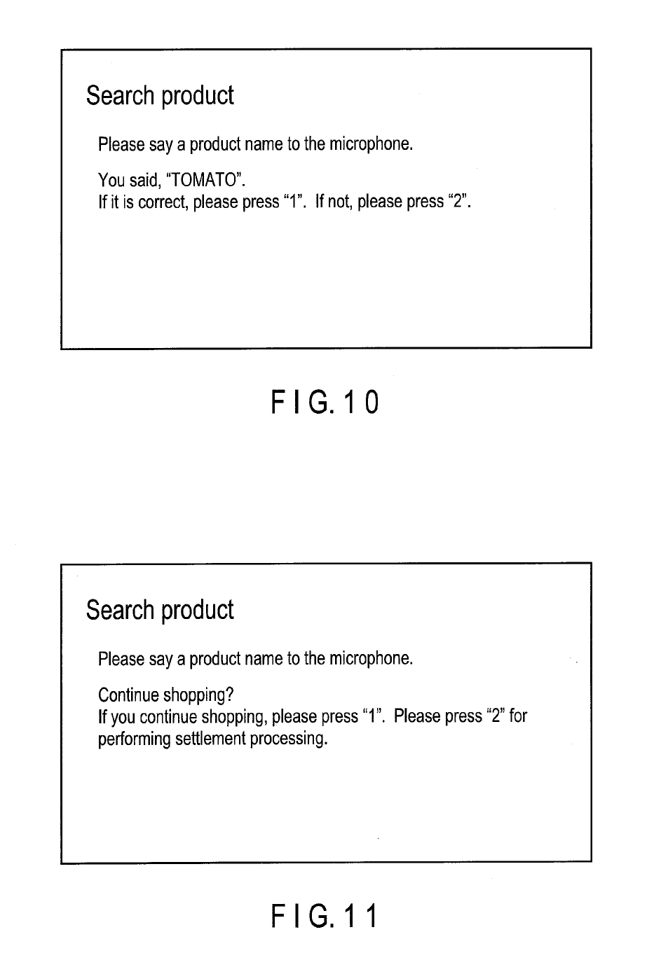

If it is determined that a product name has been found (block B19, Yes), the control function 301 executes a process to display an image (FIG. 10) asking the user whether the product name found is correct (block B20). Although it is determined that a product name input by speech exists in the product database, the user is asked to confirm that the searched product name is correct. In the display example of FIG. 10, “TOMATO” is recognized, and the user is prompted to press the key “1” if this is correct, or “2” if not.

Next, the control function 301 determines whether the recognized result is correct according to which key on the BT keyboard 40 pressed by the user (block B21). If “1” is input, the control function 301 determines that the recognized result of “TOMATO” is correct. If “2” is input, it is determined that the recognized result is not correct.

If it is determined that the recognized result is correct (block B21, Yes), the control function 301 executes a process to display an image (FIG. 11) to ask whether to continue shopping. If the user selects continuing shopping (block B22, Yes), the net shopping application 202 executes the processes from block B13 sequentially.

If the user selects settlement processing (block B22, No), the net shopping application 202 executes settlement processing (block B23).

If it is determined that a product name has not been searched in block B19 (block B19, No), the similar product name search function 307 extracts from the product database all the product names having the same number of characters as that of a recognized character string (block B24). For example, if a recognized character string is, for example, “ZAZAZA” (za-za-za [no such word]) or “TOMATO” (to-mi-to [no such word]), the number of characters is three. The similar product name search function 307 extracts all of the three-character product names in the product database shown in FIG. 4. That is, the similar product name search function 307 extracts, “TOMATO” (to-ma-to [apple]), “MOYASHI” (mo-ya-shi [sprout]), “RINGO” (ri-n-go [apple]), “SUIKA” (su-i-ka [watermelon]) and “MIKAN” (mi-ka-n [orange]). It should be noted that if a recognized character string is “KIUIFRUUTSU” (ki-u-i-fu-ru-u-tsu; [kiwi fruit]), the number of characters is seven and therefore it does not exist in the product database.

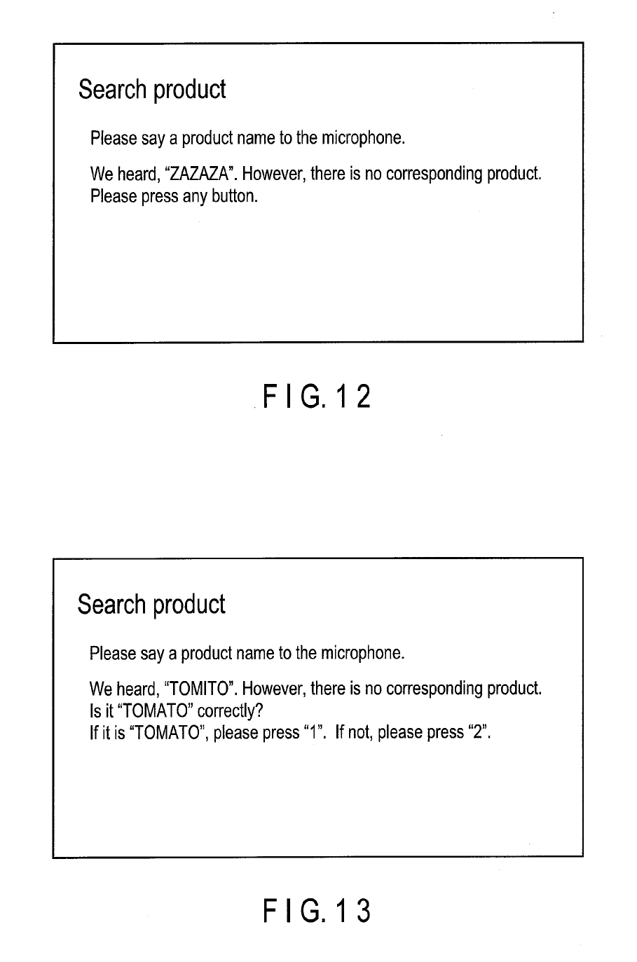

The similar product name search function 307 determines whether a product name having the same number of characters as that of a recognized character string has been extracted (block B25). If it is determined that the product name has not been extracted (block B25, No), the control function 301 executes a process to display an image (FIG. 12) that includes a message reporting that there is no product corresponding to the input speech and a message prompting the user to press a key to proceed to the next process (block B30). If an optional key is pressed, the net shopping application 202 executes the processes from block B13 sequentially.

If it is determined that a product name has been extracted (block B25, Yes), the similar product name search function 307 selects the product name having the greatest number of matching characters in a comparison of between the extracted product name with the recognized character string (block B26). For example, if a recognized character string is “TOMITO”, three-character products, “TOMATO”, “MOYASHI”, “RINGO”, “SUIKA”, and “MIKAN” are listed from the product database in FIG. 4. In this case, “TOMOTO” is selected since it has the greatest number of characters matching those in “TOMITO”. The other three-character products are not selected since there is no character matching those in “TOMITO”.

The control function 301 determines whether a selected product name is one (block B27). If it is determined that the selected product name is one (block B27, Yes), the control function 301 executes a process to display an image (FIG. 13) that asks whether the selected product name is correct (block B28). In the image shown in FIG. 13, a message is displayed, “Heard ‘TOMITO,’ but there is no corresponding product. Should this be ‘TOMATO’?” Further, a message is displayed, prompting the user to input confirmation of whether this is correct.

If the user determines that the product name is correct (block B29, Yes), the net shopping application 202 executes the processes from block B22 sequentially. If the user determines that the product name is not correct (block B29, No), the net shopping application 202 executes the processes from block B13 sequentially.

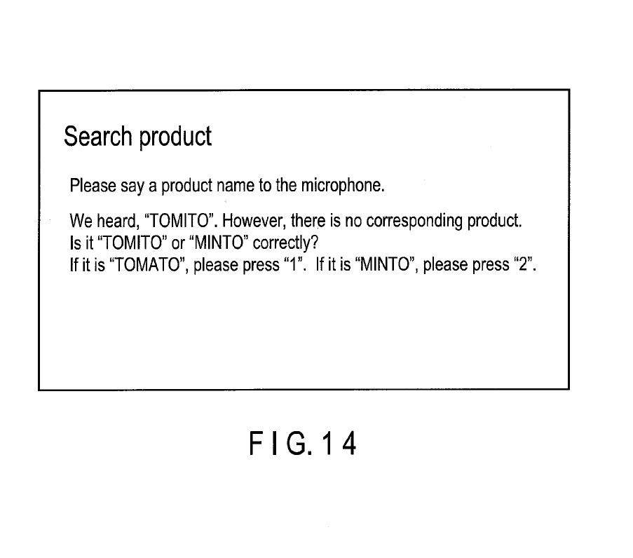

In block B27, if it is determined that a selected product is not one (block B27, No), the control function 301 reports a message that there is no product corresponding to the input speech. If a recognized character string is “TOMITO”, three-character products, “TOMATO”, “MOYASHI”, “RINGO”, “SUIKA”, “MIKAN”, and “MINTO” are listed from the product database in FIG. 5. In this case, “TOMATO” and “MINTO” are selected since they have the greatest number of characters matching those in “TOMITO”. The other three-character products are not selected since there is no character matching any of those in “TOMITO”. A process is executed to display an image (FIG. 14) that includes a message prompting the user to select a product name. In FIG. 14, a number is allocated to each product name. The user presses a key on the BT keyboard 40 representing the number corresponding to a product name, to thereby select the product name.

When the user presses a key on the BT keyboard 40, the control function 301 selects the product corresponding to the key pressed (block B32). The net shopping application 202 executes the processes from block B22 sequentially.

By the above-mentioned processes, the user can carry out net shopping by means of speech recognition.

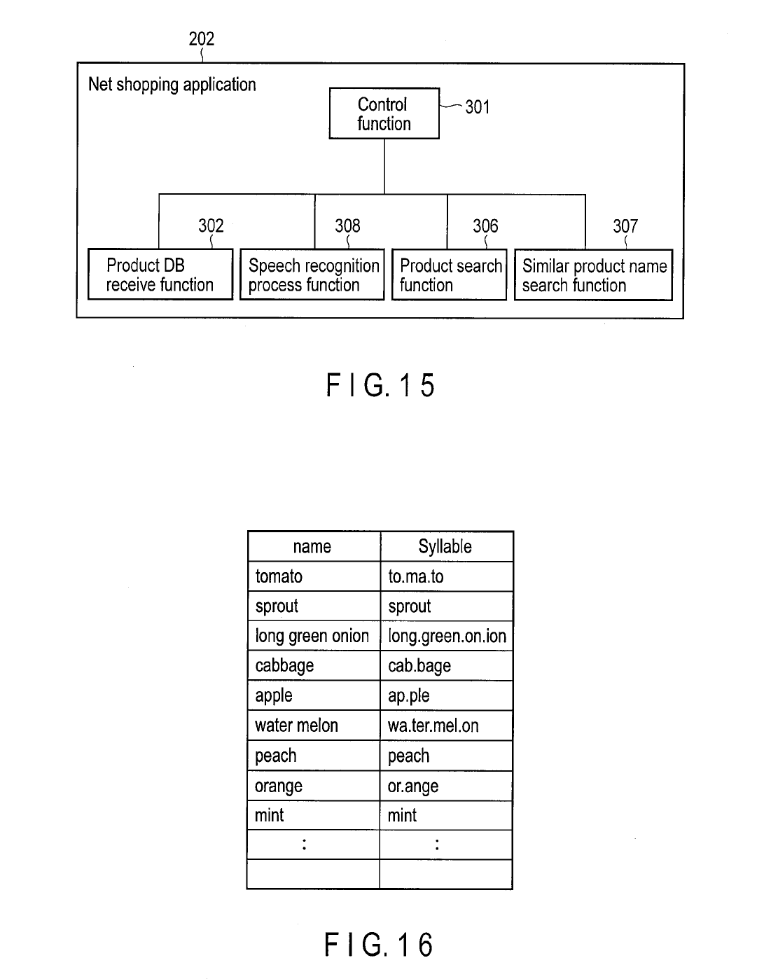

It should be noted that although a speech recognition process is executed by the speech recognition server 70, it is possible for the speech recognition process to be executed by the net shopping application 202. If the speech recognition process is executed by the net shopping application 202, as shown in FIG. 15, a speech recognition function 308 is implemented in the net shopping application 202.

Also, although image display is performed by the display apparatus 20, which is an external apparatus, it is possible for the electronic device 10 to have a display screen of an LCD 21.

The above-mentioned embodiment is premised on Japanese. As for the languages other than Japanese, the similar product name search function 307 extracts from the product database a product name having the same number of syllables as that of a character string, counts the number in which each syllable matches and takes as a recognized speech result a product name having the greatest number of matches. The similar product name search function 307 extracts all the product names, if there are a plurality of product names having the greatest number of matches. FIG. 15 shows a syllable dictionary database in which English is taken as an example. Regarding FIG. 16, product names that exist on the product database are listed in the left and the product names are syllabicated by “.(dot)” in the right. As for a product name in the languages other than Japanese, syllabication is done by searching from the dictionary database shown in FIG. 16. However, it can be expected that syllabication does not work properly in some cases. For example, if “peach” is mistyped as “beach”, since either word has only one syllable, no matches can be found in the syllable. In this case, in addition to the number of syllables by syllabication and the matching of characters in the syllable, the number of alphabetic characters and the number of character matches coincidence of each character are also used, as with Japanese.

According to the present embodiment, by presenting a product name similar to a character string shown in text data corresponding to the recognition result of voice data from a product database, even if speech is misrecognized, it becomes possible to present a name corresponding to a character string appearing in text data that represents the recognized speech result from a database having a plurality of names.

It should be noted that all the procedures of the net shopping process in the present embodiment can be executed by software. Therefore, the same effect as the present embodiment can be easily realized only by installing this program to a normal computer and executing it via a computer-readable storage medium that stores a program executing the procedure of the net shopping process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
storage configured to store a database comprising a plurality of names;
a processor configured to output an identified name based on a search of the database for a first name having one or more characteristics in common with a character string associated with speech data.

2. The device of claim 1, wherein
the one or more characteristics comprise the number of characters or the number of syllables.

3. The device of claim 2, wherein
when the search returns a plurality of names having the common characteristics, the characteristics further comprise the number of characters matching each character in the character string or the number of syllables matching each syllable in the character string.

4. The device of claim 1, further comprising:
a transmitter configured to execute a process to transmit the voice data to a first server connected to a network; and
a first receiver configured to receive the character string from the first server.

5. The device of claim 1, further comprising a recognition module configured to recognize the voice data and to generate the character string based on the recognized voice data.

6. The device of claim 4, further comprising a second receiver configured to receive the database from a second server connected to a network.

7. The device of claim 1, wherein the processor is further configured to output the identified name based on a search of the database for a second name that matches the character string associated with the speech data, wherein
when the search returns the second name, the processor is configured to output the identified name based on the search for the second name, and
when the search does not return the second name, the processor is configured to output the identified name based on the search for the first name.

8. A presentation method comprising:
searching a database comprising a plurality of names for a first name having one or more characteristics in common with a character string associated with speech data; and
outputting an identified name based on the search for the first name.

9. A computer-readable, non-transitory storage medium having stored thereon a computer program which is executable by a computer, the computer program controlling the computer to execute functions of:
searching a database comprising a plurality of names for a first name having one or more characteristics in common with a character string associated with speech data; and
outputting an identified name based on the search for the first name.
